(19) United States
(12) Patent Application Publication
(10) Pub. No.: US 2019/0251421 A1
(43) Pub. Date: Aug. 15, 2019

(54) SOURCE SEPARATION METHOD AND SOURCE SEPERATION DEVICE

(71) Applicant: National Central University, Taoyuan (TW)

(72) Inventors: Jia-Ching Wang, New Taipei City (TW); Yuan-Shan Lee, New Taipei City (TW); Shu-Fan Wang, Nantou County (TW); Chien-Yao Wang, Yunlin County (TW)

(73) Assignee: National Central University, Taoyuan (TW)

(21) Appl. No.: 15/911,174

(22) Filed: Mar. 5, 2018

(30) Foreign Application Priority Data
Feb. 14, 2018 (TW) 107105469

(51) Int. Cl. G06N 3/04; G06K 9/62; G06N 3/08

(52) U.S. Cl. CPC G06N 3/049; G06N 3/08; G06K 9/6256

(57) ABSTRACT

A source separation method and a source separation device are provided. The source separation method comprises: obtaining at least two source time-frequency signals and a mixed time-frequency signal of the at least two source time-frequency signals; disposing the mixed time-frequency signal at an input layer of a complex-valued deep neural network, and taking the at least two time-frequency signals as a target of the complex-valued deep neural network; calculating a cost function of the complex-valued deep neural network; and performing partial differential to a real part and an imaginary part of a network parameter of the complex-valued deep neural network respectively to minimize the cost function.

### CROSS-REFERENCE TO RELATED APPLICATION

This application claims the priority benefit of Taiwan application serial no. 107105469, filed on Feb. 14, 2018. The entirety of the above-mentioned patent application is hereby incorporated by reference herein and made a part of this specification.

### BACKGROUND OF THE INVENTION

### Field of the Invention

The invention relates to a source separation method and a source separation device, and particularly relates to a source separation method and a source separation device capable of training a phase of a time-frequency signal.

### Description of Related Art

Deep learning is a commonly used algorithm in signal source separation. The deep learning is adapted to convert a mixed signal from a time domain to a frequency domain through a Short-Time Fourier Transform (STFT), and obtain a magnitude of an absolute value thereof to serve as an input value of a deep neural network. Then, the deep learning obtains time-frequency data of the signal to be separated through the trained deep neural network, and then transforms the signal back to the time domain through an inverse STFT (iSTFT). However, to only use a magnitude of a spectrum of the mixed signal to serve as network training data but ignore the phase information, which is an important information implied in the STFT coefficient, may cause a poor hearing quality of the separated signal. Therefore, how to add the phase information to the deep neural network for training is a target to be achieved by related technicians of the art.

### SUMMARY OF THE INVENTION

The invention is directed to a source separation method and a source separation device, in which phase information is added to a deep neural network for training, so as to improve hearing quality of a separated signal.

The invention provides a source separation method including: obtaining at least two source time-frequency signals and a mixed time-frequency signal corresponding to the at least two source time-frequency signals; disposing the mixed time-frequency signal at an input layer of a complex-valued deep neural network, and taking the at least two source time-frequency signals as a target of the complex-valued deep neural network; calculating a cost function of the complex-valued deep neural network; and performing partial differential to a real part and an imaginary part of a network parameter of the complex-valued deep neural network respectively to minimize the cost function.

In an embodiment of the invention, the source separation method further includes: performing partial differential to the real part of the network parameter to train a magnitude of the mixed time-frequency signal.

In an embodiment of the invention, the source separation method further includes: performing partial differential to the imaginary part of the network parameter to train a phase of the mixed time-frequency signal.

In an embodiment of the invention, the source separation method further includes: taking a quadratic error as the cost function of the complex-valued deep neural network.

In an embodiment of the invention, the source separation method further includes: performing partial differential to the real part and the imaginary part of the network parameter of the complex-valued deep neural network respectively by a gradient descent method.

In an embodiment of the invention, the network parameter includes a weight value and a deviation value.

The invention provides a source separation device including a processor and a memory coupled to the processor. The processor obtains at least two source time-frequency signals and a mixed time-frequency signal corresponding to the at least two source time-frequency signals. The processor disposes the mixed time-frequency signal at an input layer of a complex-valued deep neural network, and takes the at least two source time-frequency signals as a target of the complex-valued deep neural network. The processor calculates a cost function of the complex-valued deep neural network. The processor performs partial differential to a real part and an imaginary part of a network parameter of the complex-valued deep neural network respectively to minimize the cost function.

In an embodiment of the invention, the processor performs partial differential to the real part of the network parameter to train a magnitude of the mixed time-frequency signal.

In an embodiment of the invention, the processor performs partial differential to the imaginary part of the network parameter to train a phase of the mixed time-frequency signal.

In an embodiment of the invention, the processor takes a quadratic error as the cost function of the complex-valued deep neural network.

In an embodiment of the invention, the processor performs partial differential to the real part and the imaginary part of the network parameter of the complex-valued deep neural network respectively by a gradient descent method.

In an embodiment of the invention, the network parameter includes a weight value and a deviation value.

According to the above description, the source separation method and the source separation device of the invention calculate the cost function of the complex-valued deep neural network, and perform partial differential to the real part and the imaginary part of the network parameter of the complex-valued deep neural network respectively to minimize the cost function. During the process of performing partial differential to the imaginary part of the network parameter, the phase of the mixed time-frequency signal is trained, so that the complex-valued deep neural network may acquire better quality of a separated signal.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a source separation device according to an embodiment of the invention.

FIG. 2 is a schematic diagram of a full complex-valued deep neural network according to an embodiment of the invention.

FIG. 3 is a flowchart illustrating an inverse transfer derivation of a source separation method according to an embodiment of the invention.

### DESCRIPTION OF EMBODIMENTS

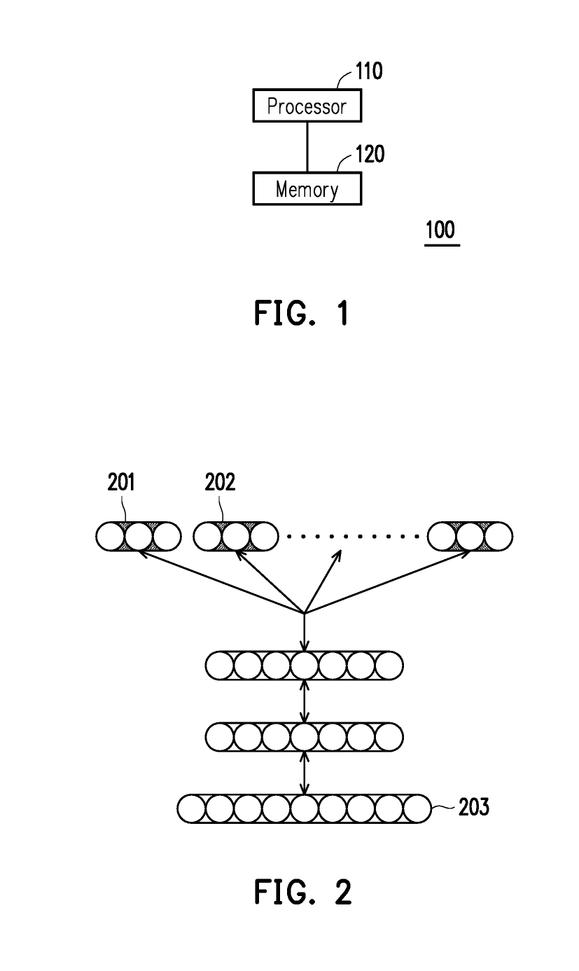

FIG. 1 is a block diagram of a source separation device according to an embodiment of the invention.

Referring to FIG. 1, the source separation device 100 of the invention includes a processor 110 and a memory 120. The memory 120 is couple to the processor 110. The source separation device 100 may be an electronic device such as a Personal Computer (PC), a server, etc., or a mobile device such as a smart phone, a tablet PC, etc., which is not limited by the invention. The processor 110 may be a Central Processing Unit (CPU), or other programmable general purpose or special purpose microprocessor, a Digital Signal Processor (DSP), a programmable controller, an Application Specific Integrated Circuit (ASIC) or other similar device or a combination of the above devices. The memory 120 may be any type of a fixed or movable Random Access Memory (RAM), a Read-Only Memory (ROM), a flash memory, a Hard Disk Drive (HDD), a Solid State Drive (SSD) or other similar device or a combination of the above devices. The processor 110 may receive a time-frequency signal from the memory 120 for training a complex-valued deep neural network of the invention.

In a forward transfer derivation of the complex-valued deep neural network, a hidden layer excitation value is x⁽¹⁾∈ [symbol] ^{N}^{⁽¹⁾}, and calculation equations (1), (2) are as follows:

net⁽¹⁾=W⁽¹⁾x+b⁽¹⁾ (1)

x⁽¹⁾=ƒ(net⁽¹⁾) (2)

In the above equations, x∈ [symbol] ^{N}^{⁽⁰⁾} is an input signal, W⁽¹⁾∈ [symbol] ^{N}^{⁽¹⁾}^{×N}^{⁽⁰⁾} is a weight value between an input layer and a hidden layer, b⁽¹⁾∈ [symbol] ^{N}^{⁽¹⁾} is a deviation value, and ƒ(·) is an excitation function. The excitation function is, for example, a Rectified Linear Unit (ReLU) of a complex-valued version, and the ReLU may function on a complex-valued domain to accelerate a convergence speed of a network.

In the forward transfer derivation of the complex-valued deep neural network, an output layer excitation value is x⁽²⁾∈ [symbol] ^{N}^{⁽²⁾}, and calculation equations (3), (4) are as follows:

net⁽²⁾=W⁽²⁾x⁽¹⁾+b⁽²⁾ (3)

x⁽²⁾=ƒ(net⁽²⁾) (4)

In the aforementioned equations, W⁽²⁾∈ [symbol] ^{N}^{⁽²⁾}^{×N}^{⁽¹⁾} is a weight value between the input layer and the hidden layer, b⁽²⁾∈ [symbol] ^{N}^{⁽²⁾} is a deviation value, and ƒ(·) is the excitation function.

FIG. 2 is a schematic diagram of a full complex-valued deep neural network according to an embodiment of the invention.

Referring to FIG. 2, the complex-valued deep neural network of the invention may use a first source time-frequency signal 201, a second source time-frequency signal 202 (or more source time-frequency signals) and a mixed time-frequency signal 203 corresponding to the first source time-frequency signal 201 and the second source time-frequency signal 202 (or more source time-frequency signals) to train a network parameter in the complex-valued deep neural network. After the training is completed, the complex-valued deep neural network may be applied to a source separation operation.

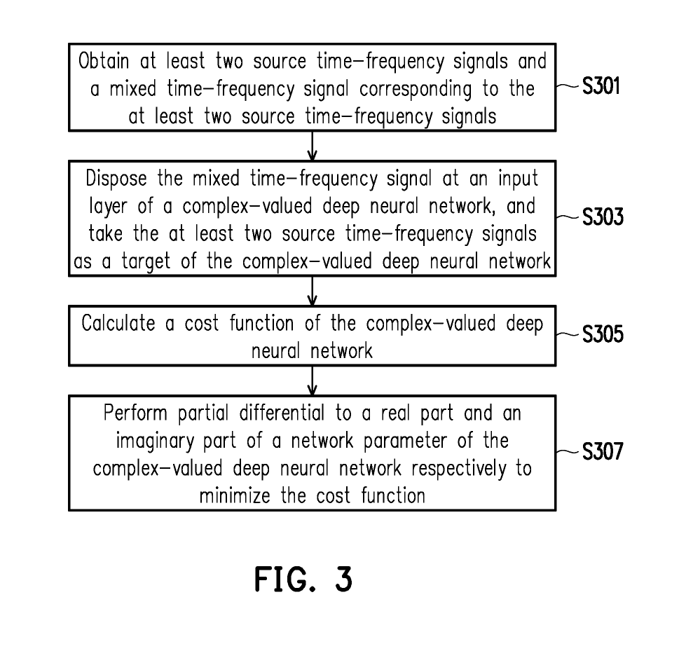

FIG. 3 is a flowchart illustrating an inverse transfer derivation of a source separation method according to an embodiment of the invention.

Referring to FIG. 3, in step S301, at least two source time-frequency signals and a mixed time-frequency signal corresponding to the at least two source time-frequency signals are obtained.

In step S303, the mixed time-frequency signal is disposed at an input layer of a complex-valued deep neural network, and the at least two source time-frequency signals are taken as a target of the complex-valued deep neural network.

In step S305, a cost function of the complex-valued deep neural network is calculated. To be specific, the source separation method of the invention first adopts a quadratic error as a cost function of the complex-valued deep neural network, where an error value output by the complex-valued deep neural network is shown as a following equation (5):

εⱼ=dⱼ−yⱼ,

j=1,2, . . . N⁽²⁾ (5)

Where, dⱼ is an expected output value of the complex-valued deep neural network, and yⱼ is predicted value, i.e. a correct result.

Therefore, a cost value (E) is calculated according to a following equation (6):

E=Σⱼ₌₁^{N}^{⁽²⁾}|εⱼ|²=Σⱼ₌₁^{N}^{⁽²⁾}εⱼε^{*}ⱼ (6)

In step S307, partial differential is performed to a real part and an imaginary part of a network parameter of the complex-valued deep neural network respectively to minimize the cost function.

To be specific, in the invention, a gradient descent method is adopted to respectively perform partial differential to the network parameters (i.e. the weight value W, the deviation value b) of the complex-valued deep neural network to iterate an optimal solution. Since E is a real function (a product of εⱼ and conjugate complex numbers thereof), which is non-analytic on a complex plane, it is unable to perform a differential operation. Therefore, it is required to perform partial differential and update to the real part Re(Wⱼₖ⁽²⁾) and the imaginary part Im(Wⱼₖ⁽²⁾) of the network parameter, and deriving results thereof are as follows:)

Wⱼₖ⁽²⁾[n+1]=Wⱼₖ⁽²⁾[n]+μ((dⱼ−yⱼ)ƒ′(netⱼ^{*(2)})xₖ^{*(1)}) (7)

bⱼ⁽²⁾[n+1]=bⱼ⁽²⁾[n]+μ((dⱼ−yⱼ)ƒ′(netⱼ^{*(2)})) (8)

Then, following equations (9), (10) are derivation between the input layer (a subscript l) and the hidden layer (a subscript k):

wₖₗ⁽¹⁾[n+1]=wₖₗ⁽¹⁾[n]+μ(Σⱼ₌₁^{N(2)}((dⱼ−yⱼ)ƒ′(netⱼ^{*(2))}wⱼₖ^{*(2)}))ƒ′(netₖ^{*(1)})xₗ^{*} (9)

bₖ⁽¹⁾[n+1]=bₖ⁽¹⁾[n]+μ(Σⱼ₌₁^{N}^{⁽²⁾}((dⱼ−yⱼ)ƒ′(netⱼ^{*(2)})wⱼₖ^{*(2)}))ƒ′(netₖ^{*(1)}) (10)

By performing partial differential to the real part of network parameter, a magnitude of the mixed time-frequency signal is trained, and by performing partial differential to the imaginary part of network parameter, a phase of the mixed time-frequency signal is trained. In the invention, since the complex-valued deep neural network is directly used to learn a Short-Time Fourier Transform (STFT) characteristic, the learned characteristic may keep an original structure of the magnitude and the phase of the signal. Moreover, in the invention, since parameters of each layer of the network are adjusted through an inverse transfer result in an iteration manner, learning of the complex-valued deep neural network is completed after iteration to convergence.

In summary, the source separation method and the source separation device of the invention calculate the cost function of the complex-valued deep neural network, and perform partial differential to the real part and the imaginary part of the network parameter of the complex-valued deep neural network respectively to minimize the cost function. During the process of performing partial differential to the imaginary part of the network parameter, the phase of the mixed time-frequency signal is trained, so that the complex-valued deep neural network may acquire better quality of a separated signal.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A source separation method, comprising:
obtaining at least two source time-frequency signals and a mixed time-frequency signal corresponding to the at least two source time-frequency signals;
disposing the mixed time-frequency signal at an input layer of a complex-valued deep neural network, and taking the at least two source time-frequency signals as a target of the complex-valued deep neural network;
calculating a cost function of the complex-valued deep neural network; and
performing partial differential to a real part and an imaginary part of a network parameter of the complex-valued deep neural network respectively to minimize the cost function.

2. The source separation method as claimed in claim 1, further comprising:
performing partial differential to the real part of the network parameter to train a magnitude of the mixed time-frequency signal.

3. The source separation method as claimed in claim 1, further comprising:
performing partial differential to the imaginary part of the network parameter to train a phase of the mixed time-frequency signal.

4. The source separation method as claimed in claim 1, further comprising:
taking a quadratic error as the cost function of the complex-valued deep neural network.

5. The source separation method as claimed in claim 1, further comprising:
performing partial differential to the real part and the imaginary part of the network parameter of the complex-valued deep neural network respectively by a gradient descent method.

6. The source separation method as claimed in claim 1, wherein the network parameter comprises a weight value and a deviation value.

7. A source separation device, comprising:
a processor; and
a memory, coupled to the processor, wherein the processor
obtains at least two source time-frequency signals and a mixed time-frequency signal corresponding to the at least two source time-frequency signals;
disposes the mixed time-frequency signal at an input layer of a complex-valued deep neural network, and takes the at least two source time-frequency signals as a target of the complex-valued deep neural network;
calculates a cost function of the complex-valued deep neural network; and
performs partial differential to a real part and an imaginary part of a network parameter of the complex-valued deep neural network respectively to minimize the cost function.

8. The source separation device as claimed in claim 7, wherein the processor performs partial differential to the real part of the network parameter to train a magnitude of the mixed time-frequency signal.

9. The source separation device as claimed in claim 7, wherein the processor performs partial differential to the imaginary part of the network parameter to train a phase of the mixed time-frequency signal.

10. The source separation device as claimed in claim 7, wherein the processor takes a quadratic error as the cost function of the complex-valued deep neural network.

11. The source separation device as claimed in claim 7, wherein the processor performs partial differential to the real part and the imaginary part of the network parameter of the complex-valued deep neural network respectively by a gradient descent method.

12. The source separation device as claimed in claim 7, wherein the network parameter comprises a weight value and a deviation value.
